(19) United States
(12) Patent Application Publication
(10) Pub. No.: US 2006/0091687 A1
(43) Pub. Date: May 4, 2006

(54) Slide out sealing system

(75) Inventors: Brent Schoffner, Hudson, OH (US); Jason Dennison, Tallmadge, OH (US)

Correspondence Address: HAHN LOESER & PARKS, LLP, One GOJO Plaza, Suite 300, AKRON, OH, 44311-1076, US

(73) Assignee: Mantaline Corporation

(21) Appl. No.: 11/263,193

(22) Filed: Oct. 31, 2005

Related U.S. Application Data
(60) Provisional application No. 60/623,443, filed on Oct. 29, 2004.
(60) Provisional application No. 60/624,054, filed on Nov. 1, 2004.

(51) Int. Cl. B60P 3/34

(52) U.S. Cl. 296/26.01

(57) ABSTRACT

A sealing system is disclosed for a vehicle having a slide out room. Slide out rooms typically have a gap between an outer wall and the slide out room, where the slide out room moves between an extended position and a retracted position. The slide out sealing system provides a seal for the gap. The slide out sealing system comprises at least one wiper seal affixed between the outer wall and the slide out room, an inner seal affixed between an interior surface of the outer wall and an interior support of the slide out room, and at least one inner seal corner junction operably affixed to a corner of the interior support. At least one wiper seal operatively contacts the slide out room, and the inner seal operatively contacts the slide out room and the outer wall when the slide out room is in the extended position.

This application claims priority from U.S. provisional applications Ser. No. 60/623,443 and Ser. No. 60/624,054, which are both hereby incorporated by reference.

### TECHNICAL FIELD OF THE INVENTION

The present invention relates to a sealing system and, more specifically, to an improved sealing system for slide out rooms.

### BACKGROUND

A variety of vehicles, whether motorized or towed, contain extendable portions for increasing the interior spaces of the vehicles. These extendable portions are commonly included as slide out rooms. Slide out rooms typically extend from an outer wall of the vehicle, and move between a retracted position and an extended (expanded) position. Many slide out rooms move between the retracted and extended positions in an approximately linear motion.

While the vehicle is in motion, the slide out room is in the retracted position. When the vehicle reaches its destination, a user moves the slide out room to the extended position for use. Slide out rooms are popular and commonly included on recreational vehicles (“RVs”) and other temporary housing units. In an RV, slide out rooms increase the living space, adding comfort and enjoyment.

Whether the slide out room is in the extended or retracted position, it is desirable that the interior space of the vehicle be sealed from the outdoor environment. However, the outer wall of the vehicle has an opening for the slide out room to pass through. This opening is a potential place for dirt, water, and outside air to leak into the vehicle. Slide out rooms in the prior art use a variety of compressible seals to close gaps between the slide out room and the exterior wall of the vehicle.

Due to complexities and irregularities in the structure and the translational nature of the slide out room, proper sealing has been difficult and inconsistent. Further, there remains a need for a sealing system that is easy to produce and more affordable for original manufacturers and aftermarket purchasers. Accordingly, there is a need for a slide out sealing system that provides an improved sealing system at reasonable costs.

### SUMMARY OF THE INVENTION

A first embodiment of the present invention is a slide out sealing system for a recreational vehicle (RV) having a gap between a slide out room and a recessed slide out room cavity within the RV, the gap comprising a first gap between an outer slide wall and an outer RV wall and a second gap between an interior end wall and the outer RV wall, wherein the slide out room moves between an extended position and a retracted position, the slide out sealing system comprising: at least one wiper seal affixed to the outer RV wall, the at least one wiper seal extending between the outer RV wall and the outer slide wall and contacting the outer slide wall; and a means for sealing the gap between the interior end wall and the outer RV wall, the means comprising an inner seal and at least one inner seal corner junction, wherein the inner seal and the at least one inner seal corner junction operatively contact the interior end wall, the outer slide wall, and the outer RV wall when the slide out room is in the extended position.

A second embodiment of the present invention is a slide out sealing system for a recreational vehicle (RV) having a gap between an outer RV wall and a slide out room, wherein the slide out room moves between an extended position and a retracted position, and wherein the slide out room includes an outer slide wall and an interior end wall, the slide out sealing system comprising: at least one wiper seal operably attached to the outer RV wall and contacting the outer slide wall; and a seal assembly affixed about a perimeter of the slide out room between the interior end wall and an interior surface of the outer RV wall, the seal assembly comprising: an inner seal; and at least one inner seal corner junction operably attaching to the inner seal, wherein the seal assembly operatively contacts the inner slide wall, the outer slide wall, and the outer RV wall when the slide out room is in the extended position.

A third embodiment of the present invention is a slide out sealing system for a recreational vehicle having a slide out room that moves between a retracted position and an extended position, the system comprising: an outer wiper seal operably attached to the recreational vehicle, the outer wiper seal comprising an elongated cross sectional shape having a first end, a second end, and a thickened portion, where the first end includes a fastening portion for attaching the outer wiper seal to the recreational vehicle and where the thickened portion is positioned near the second end; an inner wiper seal operably attached to the recreational vehicle, the inner wiper seal comprising an elongated cross sectional shape having a first end, a second end, and a thickened portion, where the first end includes a fastening portion for attaching the inner wiper seal to the recreational vehicle and where the thickened portion is positioned near the second end; an inner seal operably attached to the an interior portion of the slide out room, the inner seal comprising a loop-shaped portion and a base, the loop-shaped portion having a substantially straight inclined wall extending from the base and a curved member extending outwardly from the inclined wall to the base, wherein the base has a pair of mounting legs projecting outwardly therefrom, the pair of legs being connected with the base to form a planar mounting surface and comprising a less flexible material than the remaining portions of the inner seal; and an inner seal corner junction operably attached an interior corner of an interior end wall of the slide out room, the junction having two base segments that intersect to form a corner, the segments having approximately the same cross sectional shape as the inner seal, wherein each base has a mating extension extending therefrom, where each mating extension is dimensioned to allow the inner seal to mount thereto.

The advantages of the improved slide out sealing system will be apparent upon review of the detailed description of the present invention and associated drawings below.

### BRIEF DESCRIPTION OF THE DRAWINGS

FIG. 1 is a side perspective view of a vehicle with a slide out sealing system of the present invention;

FIG. 2 is a partial cross-sectional view of the slide out sealing system of FIG. 1;

FIG. 3 is a cross-sectional view of an outer wiper of the present invention;

FIG. 4 is a cross-sectional view of a first embodiment of an inner wiper of the present invention;

FIG. 5 is a cross-sectional view of a second embodiment of the inner wiper of the present invention;

FIG. 6 is a cross-sectional view of a wiper connector of the present invention;

FIG. 7 is a perspective view of an interior seal of the present invention;

FIG. 8 is a cross-sectional view of the interior seal of FIG. 7;

FIG. 9 is a perspective view of a first embodiment of an interior seal corner junction of the present invention;

FIG. 10 is a bottom view of the first embodiment of the interior seal corner junction of FIG. 9; and

FIG. 11 is a perspective view of a second embodiment of the interior seal corner junction of the present invention;

FIG. 12 is a top view of the second embodiment of the interior seal corner junction of FIG. 11.

### DETAILED DESCRIPTION OF THE INVENTION

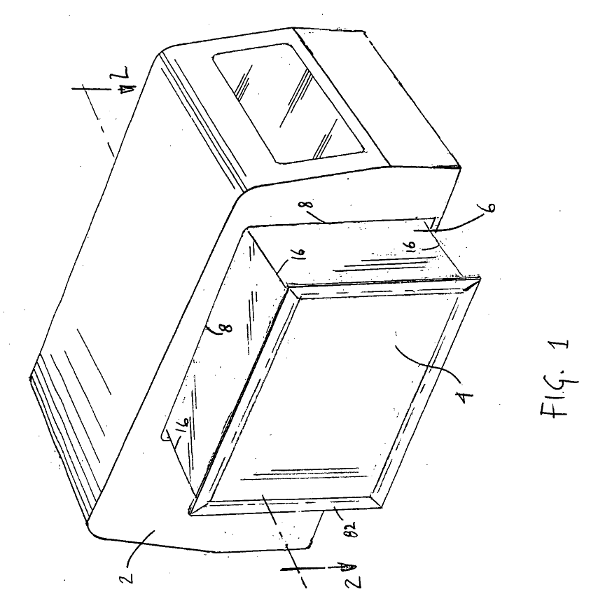

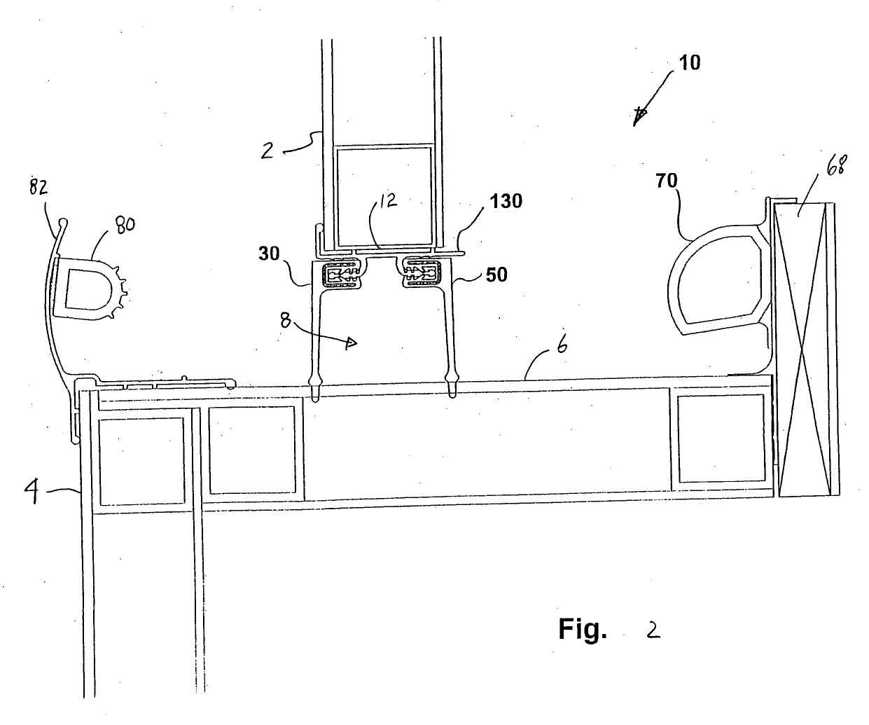

FIGS. 1 and 2 illustrate a vehicle with a slide out sealing system 10. The vehicle has a structure defining an interior area. The vehicle structure comprises an outer wall 2 and an aperture 8 through the outer wall 2. The aperture 8 has an aperture face 12, formed by the thickness of the outer wall 2. The aperture 8 is adapted to accommodate a slide out 4, which moves between a retracted position and an extended (expanded) position. The slide out 4 comprises a slide wall 6, positioned substantially parallel to and spaced away from the aperture face 12. Consequently, there is a gap between the slide wall 6 and the aperture face 12 at the slide out seam.

The system 10 provides seals between the outer wall 2 and the slide out 4, sealing the gap between the slide wall 6 and the aperture face 12 on the sides, top, and bottom. In one embodiment, the sealing system comprises an outer wiper 30, an inner wiper 50, an inner seal 70, an inner seal corner junction 90, and a wiper connector 130. The sealing system may further comprise an outer compression seal 80, attached to the slide out 4 by a seal mount 82.

The outer wiper 30 extends between the aperture face 12 and the slide wall 6 to cover the gap adjacent to an exterior portion of the outer wall 2. The inner wiper 50 assists the outer wiper 30 by providing a second seal between the aperture face 12 and the slide wall 6 adjacent to an interior portion of the outer wall 2. The arrangement of the outer wiper 30 and inner wiper 50 accommodates variations and irregularities in the size of the gap, especially where the slide wall 6 and the aperture face 12 are not parallel. In the embodiment of FIG. 2, the outer wiper 30 and inner wiper 50 are mounted to the outer wall by connector 130.

The inner seal 70 attaches to the slide out 4, providing an additional seal when the slide out is in or near the extended position. In the embodiment of FIG. 2, the inner seal 70 is mounted to an interior support (or interior end wall) 68, where the interior support 68 is approximately parallel to the outer wall 2. In this embodiment, the inner seal 70 engages the interior surface of the outer wall 2 and the inner wiper 50.

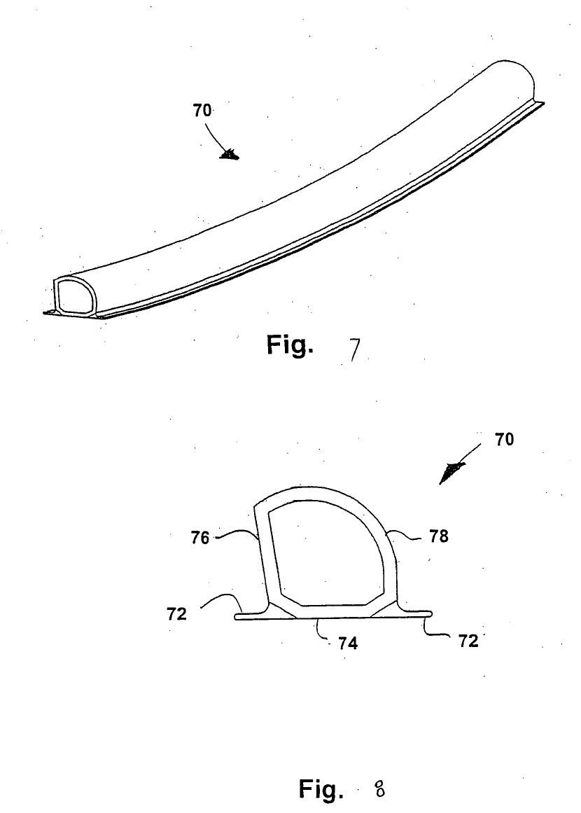

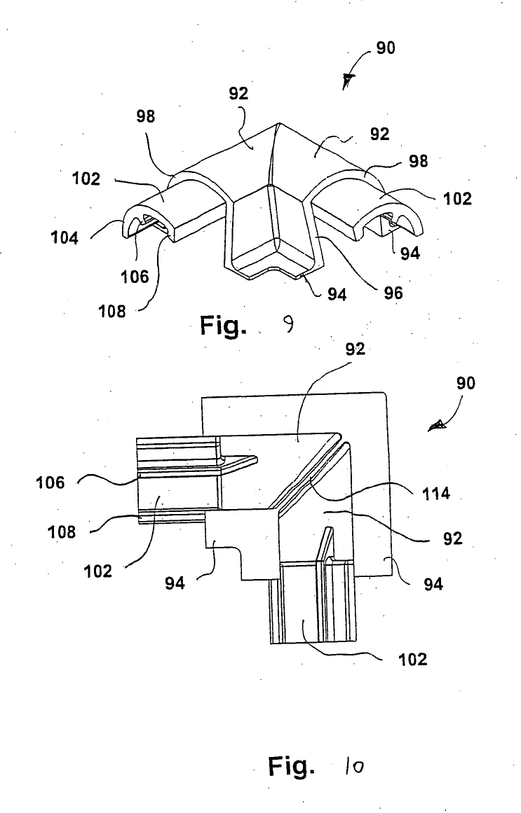

The slide wall 6 extends around the sides, top, and bottom of the slide out 4. Where the sides meet the top or bottom of the slide out 4, there is a slide wall corner 16. To provide continuous sealing in the corners 16, the inner seal 70 engages a corner junction 90 as shown in FIGS. 9 and 10.

The length of the wiper seals 30, 50, 250, the inner seals 70, 90, 290, and the outer seal 80 depend on size of the slide out room, and consequently the length of the gap to be sealed. The length of the seals should operatively fill the entire length of the gap to provide an effective seal around the slide out 4.

In the embodiment of FIG. 2, the wipers 30, 50 and the seals 70, 80 are extruded from a flexible elastomeric material. Corner junction 90 is molded from a flexible elastomeric material. The flexible elastomeric materials of the present invention may be selected from a variety of industry-known elastomers or rubber.

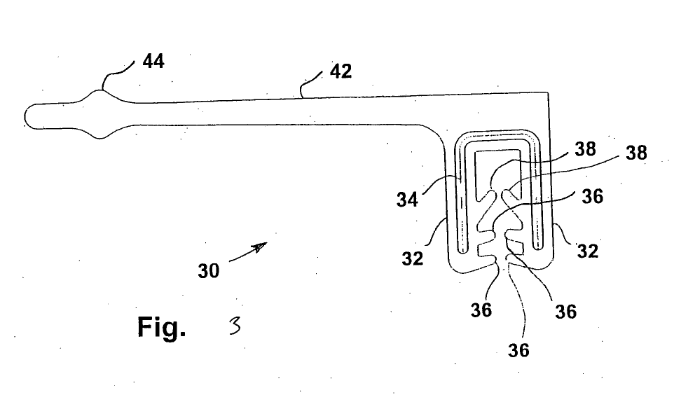

As detailed in FIG. 3, the cross sectional shape of the outer wiper 30 consists of an elongated wiper base 42 having a thickened portion 44 near a first end and two extending walls 32 near a second end. The elongated wiper is adapted to slide along the slide wall 6 as the slide out 4 moves between the retracted and extended positions. The thickened portion 44 enables the wiper to flip, changing the side contacting the slide wall 6 when the slide out translation direction changes. The two extending walls 32 extend in a substantially perpendicular direction from the base 42 to form a cavity for placing a fastener, such as a fastening protrusion 136 from the wiper connector 130 as shown in FIG. 6. Although walls 32 extend substantially parallel to each other, it is contemplated that certain fastener designs may require other parallel or non-parallel orientations.

Each wall 32 contains fastener retaining ribs 36, which extend from the interior portion of the wall 32 in a direction away from the cavity opening. Ribs 36 seek to center the fastener, such as a fastening protrusion 136, along its elongated portion. A substantially inclined rib 38 resists the removal of an inserted fastener, the design of rib 38 depending on the design of the inserted fastener. A stiffening member 34 is included within wiper 30 to provide a more rigid elastic structure, allowing the walls 32 to function as a clip. In one embodiment, each wall 32 includes a portion of the stiffening member 34, the member 34 remaining unitary in cross section as it extends from the first of the walls 32, around the fastening cavity, and to the remaining wall 32. This member 34 may be metallic or plastic.

Referring to FIG. 4, a first embodiment of inner wiper 50 has a cross sectional shape consisting of an elongated wiper base 62, a thickened portion 64, two extending walls 52, ribs 56, 58, and stiffening member 54. In the embodiment of FIG. 4, the inner wiper 50 has a similar design and function as outer wiper 30. It is contemplated that some outer wall 2 and slide out 4 designs may require different inner wiper 50 shapes, sizes, and configurations.

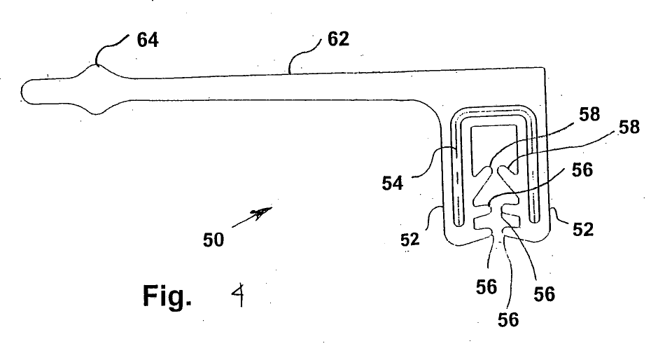

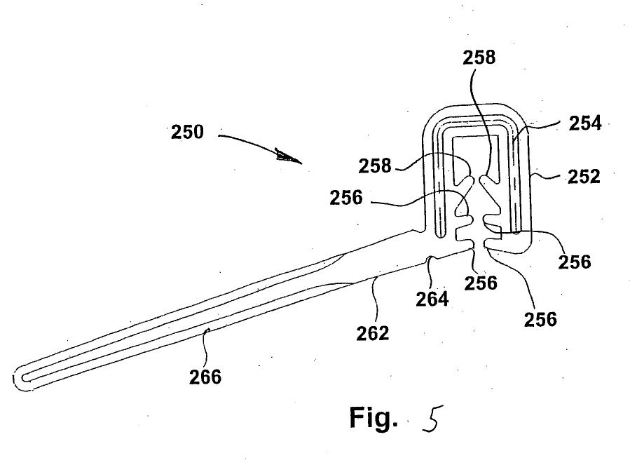

In a second embodiment shown in FIG. 5, the inner wiper 250 has a cross sectional shape consisting of a connecting portion 252 and an elongated wiper portion 262. The connecting portion 252 is U-shaped, to form a fastener cavity having an opening. On the interior of the connecting portion 252, a pair of ribs 256 and a substantially inclined rib 258 extend from each of the opposing interior side walls. The wiper portion 262 is elongated and includes a flexing end 264. The flexing end 264 maintains a reduced cross-sectional area, thereby providing a pivot point that allows the wiper portion 262 to rotate and change its orientation in relation to the slide out 4 when the translational direction of the slide out 4 changes. The flexing end 264 also joins the connecting portion 252 to the wiper portion 262. Wiper portion 262 may include a tapered portion 266 opposite the flexing end 264.

The length of the elongated portion of the wipers 30, 50, 250 may be dependent on the size of the gap between the outer wall 2 and the slide out 4. Consequently, when the distance between the aperture face 12 and the slide wall 6 is larger, the elongated portion of the wipers will be longer to fill the gap. Conversely, when the distance between the aperture face 12 and the slide wall 6 is smaller, the elongated portion of the wipers will be shorter.

The positioning of the outer wiper 30 and the inner wiper 50, 250, as shown in FIG. 2 (not showing wiper 250), prevents the wipers from adversely interacting with each other. If the wipers are too close together, one wiper may interfere with the other, reducing the effectiveness of both wipers.

The wiper connector 130, shown in FIG. 6, provides one way for attaching the outer wipers 30 and the inner wipers 50, 250 to the outer wall 2. The connector 130 of this embodiment has a cross sectional shape consisting of a base 132, a leg 134, and two fastening protrusions 136. The base 132 provides an area for mounting the connector 130 to the outer wall 2. The connector 130 may include one or more holes 138 for a typical fastener such as a rivet, screw, bolt, or other commercial fastener. Other mounting alternatives may be used, such as welding or chemical adhesives. The leg 134 strengthens the connector 130 and serves as a mounting guide, making alignment of the connector 130 on the outer wall 2 easier and more consistent.

The two fastening protrusions 136 have arrow-like ends, which engage with ribs 38, 58, 258 of wipers 30, 50, 250 to resist removal. Although protrusions 136 shown in FIG. 6 extend away from each other, it is contemplated that they may extend in the same direction or in other orientations based upon the configuration of the stationary structure and slide out seam. The connector 130 may be extruded from aluminum or other rigid materials, such as polyvinyl chloride or other rigid plastics. It is contemplated that the connector 130 may be formed by other means, such as molding, casting, forging or stamping, and from other plastic or metal materials.

In the embodiment of FIG. 6, to install the wiper seals 30, 50, 250, an operator may slide the extending wall portion 32, 52, 252 of the wiper seal over the fastening protrusion 136 of the wiper connector 130, beginning at one end of the wiper connector and sliding the wiper into place. Alternately, the operator may directly press the extending wall portion 32, 52, 252 over the fastening protrusion 136. The shapes of the fastening protrusion 136 and the corresponding wiper ribs 38, 58, 258 are selected to provide improved installation and improved retention of the wiper seals 30, 50, 250. The wiper seals 30, 50, 250 may be attached to the wiper connector 130 before or after the wiper connector is affixed to the outer wall 2.

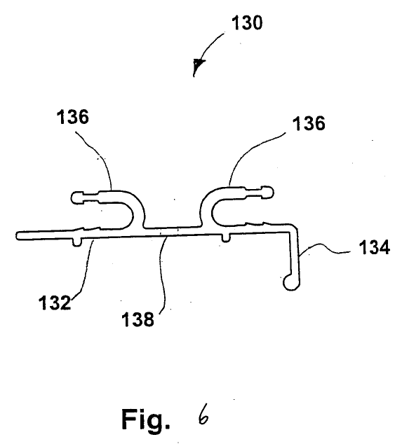

Referring to FIGS. 7 and 8, the inner seal 70 has a cross sectional shape consisting of a loop-like structure. In one embodiment, the inner seal includes legs 72 made of an elastomeric or plastic material less flexible or of a higher durometer than the material of the remaining portions of the seal 70, for providing improved mounting properties. However, it is contemplated that one material may be used for the entire seal 70, depending upon the application. In the embodiment of FIG. 8, a base 74 connects the legs 72 and completes a planar mounting surface for the seal 70. An inclined wall 76 extends approximately vertically from seal 70.

When the seal 70 compresses as the slide out 4 moves toward the extended position, the flattening seal 70 causes the upper portion of the inclined wall 76 to displace toward the slide wall 6. In the embodiment of FIG. 2, the seal 70 is positioned so that when the slide out 4 is in the extended position, the upper portion of the inclined wall 76 is pressing against the slide wall 6, providing enhanced sealing. Curved wall 78 extends outwardly from the inclined wall 76 to the leg 72 and base 74. In the embodiment of FIG. 2, the curved wall 78 contacts the interior surface of the outer wall 2 and the inner wiper 50 when the slide out structure is fully, or near fully, extended. It is contemplated that the curved wall 78 may effectively provide a seal when positioned to only contact the outer wall 2, or only contact the inner wiper 50.

FIGS. 9 and 10 show a first embodiment of the inner seal corner junction 90. The corner junction 90 comprises two base segments 92 and corresponding mating extensions 102. Generally, the base segments 92 have the same cross-sectional geometry as the inner seal 70, consisting of legs 94, inclined vertical wall 96, and curved wall 98. The base segments 92 each have a 45-degree end, which join the other to form a 90-degree corner. It is contemplated that other interior angles may exist depending on the design of the slide out 4, thereby requiring junction angles other than 90 degrees. At the intersection of base segments 92, there may be a partition 114. The partition 114 not only separates the respective inside portions of the base segments 92, it provides structural integrity by increasing the rigidity of the corner junction 90 and reducing stress that may otherwise exist at the base intersection.

Two mating extensions 102 project out from each respective base segment 92. Each extension 102 consists of a curved body 104, interior strengthening rib 106, and strengthening end rib 108. The curved body 104 projects from the base segment 92, sized and positioned to slide into the profile of inner seal 70. When the corner junction 90 is installed with the inner seal 70, the inner seal 70 mounts flush and inline with the corresponding base segment 92. Strengthening ribs 106 and 108 increase the bending moment resistance for extension 102, running continuously along a substantial portion of the length of the extension 102. In this embodiment, corner junction 90 may be molded in one piece.

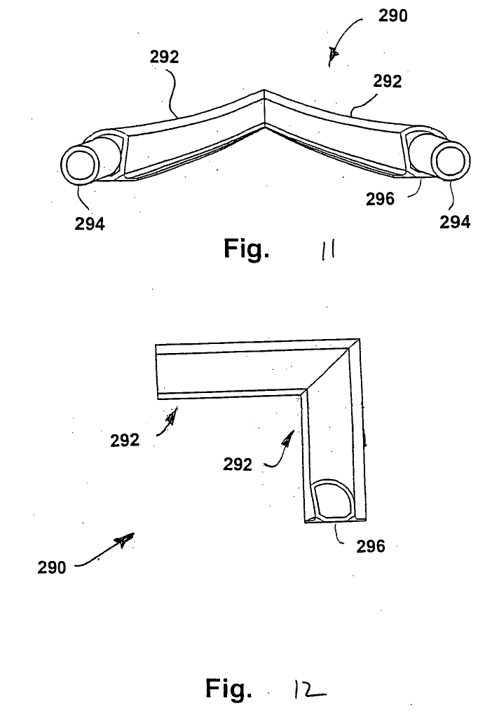

In a second embodiment, referring to FIGS. 11 and 12, the inner seal corner junction 290 comprises two base segments, or inner seal segments, 292 and mating tubes 294. The inner seal segments 292 are simply portions of the inner seal 70 cut to a predetermined length, having one end cut along the vertical plane, perpendicular to the mounting surface 296, at an angle equal to one-half of the corner to be sealed. If the corner to be sealed is a 90-degree corner, each inner seal segment end is cut at a 45-degree angle. In one embodiment, the inner seal segments 292 are joined together by industry standard methods, such as vulcanized joint, adhesive bonded joint, or heat bonded joint. Mating tubes 294 are sized and positioned to fit within the hollow portion of segments 292 and inner seal 70, to join the mating inner seal 70 to the corner junction 290. When the corner junction 290 is installed with the inner seal 70, the inner seal 70 mounts flush and inline with the corresponding inner seal segment 292. The tubes 294 are preferably made from the same as, or material similar to, the material used in the inner seal 70, although other materials may suffice.

The corner junctions 90, 290 provide sealing capability in the interior end wall corners 16. The corner junctions 90, 290 also improve the aesthetics of the seals in the corner.

The embodiment of FIG. 2 includes the outer compression seal 80. Outer seal 80 is affixed to the seal mount 82, positioned on an exterior surface of the slide out 4. The seal mount 82 extends over at least a portion of the slide out seam to protect the seam and provide an area to mount the outer compression seal 80. The outer seal 80 is positioned to engage the exterior portion of the outer wall 2 or the outer wiper 30, or both the outer wall 2 and the outer wiper 30.

While this invention has been described and illustrated with reference to various embodiments, it shall be understood that such description is by way of illustration and not by way of limitation. Accordingly, the scope and content of the present invention are to be defined only by the terms of the appended claims.

I claim the following:

1. A slide out sealing system for a recreational vehicle (RV) having a gap between a slide out room and a recessed slide out room cavity within the RV, the gap comprising a first gap between an outer slide wall and an outer RV wall and a second gap between an interior end wall and the outer RV wall, wherein the slide out room moves between an extended position and a retracted position, the slide out sealing system comprising:
at least one wiper seal affixed to the outer RV wall, the at least one wiper seal extending between the outer RV wall and the outer slide wall and contacting the outer slide wall; and
a means for sealing the gap between the interior end wall and the outer RV wall, the means comprising an inner seal and at least one inner seal corner junction,
wherein the inner seal and the at least one inner seal corner junction operatively contact the interior end wall, the outer slide wall, and the outer RV wall when the slide out room is in the extended position.

2. The slide out sealing system of claim 1, wherein the means for sealing is operably attached to the interior end wall.

3. The slide out sealing system of claim 1, wherein the inner seal comprises:
a loop-shaped portion comprising a substantially straight inclined segment and a curved segment; and
a base,
wherein a portion of the substantially straight inclined segment contacts the slide wall when the slide out room is in the extended position, and wherein a portion of the curved segment operatively contacts the outer wall when the slide out room is in the extended position.

4. The slide out sealing system of claim 3, wherein the base of the inner seal comprises a material less flexible than the loop-shaped cross section.

5. The slide out sealing system of claim 1, wherein the inner seal contacting the outer RV wall when the slide out room is in the extended position comprises the inner seal contacting an at least one wiper seal.

6. The slide out sealing system of claim 1, wherein each at least one wiper seal comprises:
an elongated segment having an attached end and a free end, the segment having a wiper flipping thickened portion positioned near the free end of the elongated segment,
wherein the free end of the elongated segment contacts the outer slide wall.

7. The slide out sealing system of claim 1, further comprising:
a wiper connector affixed to the outer wall,
wherein the at least one wiper seal is operably affixed to the wiper connector.

8. The slide out sealing system of claim 1, wherein the at least one wiper comprises:
an outer wiper affixed to a wiper connector and positioned adjacent to an exterior surface of the outer RV wall; and
an inner wiper affixed to the wiper connector and positioned adjacent to an interior surface of the outer RV wall,
wherein the outer wiper and inner wiper are positioned so that the outer wiper cannot contact the inner wiper during operation the wipers.

9. The slide out sealing system of claim 1, the at least one inner seal corner junction comprising:
two base segments substantially forming an interior sealing corner, the base segments being separated by a reinforcing partition; and
a mating extension extending from each base segment;
wherein the base segments have approximately the same cross-sectional shape as the inner seal, and the mating extensions fit inside the cross sectional profile of the inner seal.

10. The slide out sealing system of claim 9, wherein the inner seal corner junction is monolithic.

11. A slide out sealing system for a recreational vehicle (RV) having a gap between an outer RV wall and a slide out room, wherein the slide out room moves between an extended position and a retracted position, and wherein the slide out room includes an outer slide wall and an interior end wall, the slide out sealing system comprising:
at least one wiper seal operably attached to the outer RV wall and contacting the outer slide wall; and
a seal assembly affixed about a perimeter of the slide out room between the interior end wall and an interior surface of the outer RV wall, the seal assembly comprising:
an inner seal; and
at least one inner seal corner junction operably attaching to the inner seal,
wherein the seal assembly operatively contacts the inner slide wall, the outer slide wall, and the outer RV wall when the slide out room is in the extended position.

12. The slide out sealing system of claim 11, wherein the inner seal comprises:
a loop-shaped portion comprising a substantially straight inclined segment and a curved segment; and
a base,
wherein a portion of the substantially straight inclined segment contacts the slide wall when the slide out room is in the extended position, and wherein a portion of the curved segment operatively contacts the outer wall when the slide out room is in the extended position.

13. The slide out sealing system of claim 12, wherein the base of the inner seal comprises a material less flexible than the loop-shaped cross section.

14. The slide out sealing system of claim 11, wherein the inner seal contacting the outer RV wall when the slide out room is in the extended position comprises the inner seal contacting an at least one wiper seal.

15. The slide out sealing system of claim 11, wherein each at least one wiper seal comprises:
an elongated segment having an attached end and a free end, the segment having a wiper flipping thickened portion positioned near the free end of the elongated segment,
wherein the free end of the elongated segment contacts the outer slide wall.

16. The slide out sealing system of claim 11, wherein the at least one wiper comprises:
an outer wiper affixed to the wiper connector and positioned adjacent to an exterior surface of the outer RV wall; and
an inner wiper affixed to the wiper connector and positioned adjacent to an interior surface of the outer RV wall,
wherein the outer wiper and inner wiper are positioned so that the outer wiper cannot contact the inner wiper during operation the wipers.

17. The slide out sealing system of claim 11, the at least one inner seal corner junction comprising:
two base segments substantially forming an interior sealing corner, the base segments being separated by a reinforcing partition; and
a mating extension extending from each base segment;
wherein the base segments have approximately the same cross-sectional shape as the inner seal, and the mating extensions fit inside the cross sectional profile of the inner seal.

18. A slide out sealing system for a recreational vehicle having a slide out room that moves between a retracted position and an extended position, the system comprising:
an outer wiper seal operably attached to the recreational vehicle, the outer wiper seal comprising an elongated cross sectional shape having a first end, a second end, and a thickened portion, where the first end includes a fastening portion for attaching the outer wiper seal to the recreational vehicle and where the thickened portion is positioned near the second end;
an inner wiper seal operably attached to the recreational vehicle, the inner wiper seal comprising an elongated cross sectional shape having a first end, a second end, and a thickened portion, where the first end includes a fastening portion for attaching the inner wiper seal to the recreational vehicle and where the thickened portion is positioned near the second end;
an inner seal operably attached to the an interior portion of the slide out room, the inner seal comprising a loop-shaped portion and a base, the loop-shaped portion having a substantially straight inclined wall extending from the base and a curved member extending outwardly from the inclined wall to the base, wherein the base has a pair of mounting legs projecting outwardly therefrom, the pair of legs being connected with the base to form a planar mounting surface and comprising a less flexible material than the remaining portions of the inner seal; and
an inner seal corner junction operably attached an interior corner of an interior end wall of the slide out room, the junction having two base segments that intersect to form a corner, the segments having approximately the same cross sectional shape as the inner seal, wherein each base has a mating extension extending therefrom, where each mating extension is dimensioned to allow the inner seal to mount thereto.

19. The slide out sealing system of claim 18, wherein the substantially straight inclined wall of the inner seal contacts the interior end wall and the curved member of the inner seal contacts, an outer slide wall of the slide out room and an outer wall of the recreational vehicle when the slide out room is in the extended position.

20. The slide out sealing system of claim 19, wherein the second end of the outer wiper and the second end of the inner wiper operatively contact the slide out room.
